(19) United States
(12) Patent Application Publication
(10) Pub. No.: US 2009/0177330 A1
(43) Pub. Date: Jul. 9, 2009

(54) WIRELESS MOISTURE PROBE, RECEIVING CONTROLLER AND IRRIGATION CONTROL SYSTEM

(76) Inventor: Carl L.C. Kah, JR., North Palm Beach, FL (US)

Correspondence Address: OSTROLENK FABER GERB & SOFFEN, 1180 AVENUE OF THE AMERICAS, NEW YORK, NY, 100368403, US

(21) Appl. No.: 12/340,427

(22) Filed: Dec. 19, 2008

Related U.S. Application Data
(60) Provisional application No. 61/015,566, filed on Dec. 20, 2007.

(51) Int. Cl. G05D 7/06; G06F 19/00

(52) U.S. Cl. 700/284; 702/2

(57) ABSTRACT

A control system for controlling at least one irrigation station in an irrigation system in accordance with an embodiment of the present application includes a moisture probe operable to gather moisture information regarding moisture present in soil at the irrigation station and to periodically transmit the moisture information wirelessly and a controller operable to receive the moisture information and operable to provide control signals to control the irrigation station based on the moisture information to maintain a desired moisture level at the water station.

### CROSS-REFERENCE TO RELATED APPLICATIONS

The present application claims benefit of and priority to U.S. Provisional Patent Application Ser. No. 61/015,566 entitled EVAPORATIVE AND TRANSPIRATION (ET) REPORTING SOIL MOUNTED MOISTURE SENSOR PROBE PERIODIC TRANSMITTING WIRELESS MOISTURE PROBE filed Dec. 20, 2007, the entire contents of which are hereby incorporated by reference herein.

### BACKGROUND

1. Field of the Disclosure

The present disclosure relates to weather and moisture sensing for control of irrigation system watering programs. More specifically, the present application relates to a control system including a soil mounted moisture probe that provides information regarding moisture conditions in the soil wirelessly to a controller.

2. Related Art

There are many irrigation controllers on the market that use weather station data from their own weather stations, which may sense precipitation, wind velocity and temperature, for example, to calculate irrigation requirements in a local area. Some controllers may use information from daily, regional or local area weather updates provided from weather stations which may be government-owned and positioned throughout the United States. Information from these stations is typically delivered via NOAA Weather satellites. Based on the daily updates, irrigation schedules can be adjusted automatically to save water or ensure adequate watering.

The latest smart irrigation controllers require users to provide a wide variety of information for each irrigation station controlled by the controller. For example, the precipitation rate (PR) value for each sprinkler must be provided in conventional controllers. Thus, customers must make decisions as to the PR and what type of sprinkler is in each zone; i.e. spray heads, fixed, full circle rotor, part circle rotor, mixed rotors, full circle impacts, part circle impacts, mixed impacts, bubblers, drip emitters or stream rotors. Each type of sprinkler may have a different PR value.

In addition, most smart controllers also require entry of the sprinkler efficiency rating of uniformity for each type of sprinkler (generally referred to as the scheduling coefficient) to ensure that run times are sufficiently long to get the driest area in the zone of each sprinkler to the average precipitation required to replace the loss of soil moisture due to evaporation and transpiration losses (ET) of the plants in each area.

Although services publish average ETs for each zip code location, these values do not take into account plant types, shade, or geographic features, such as hills, for example. Soil types, typically including sandy, sandy loam, loam, clay loam, and clay also need to be entered for each irrigation zone station. However, many homeowners simply not know the correct soil information for each zone of their controlled irrigation system.

Contemporary controllers generally require that the user identify plant type in each irrigation zone. Plant types may include warm season grass, combined grass, flowers, trees, shrubs-high water use, shrubs-medium water use, shrubs-low water use, mixed-high water use, mixed-medium water use, mixed-low water use, native trees and shrubs, native grasses. With all these options, users may be confused as to how the proper plant type for each zone should be identified.

Customers are also asked to select microclimate conditions in each zone, or station, of their irrigation system. These microclimates may include: sunny all-day; sunny most of the day; shade most of the day; and shady all day. These selections change seasonally in areas that don't freeze and the irrigation system is used year round.

The customer is also typically asked to input location information for each irrigation controller station sprinkler such as: all parts of slope; top of slope; middle of slope; and bottom of slope.

The customer is asked to make judgments about useable rainfall as a percentage of irrigation requirements for each of the sprinkler controller stations as well.

Individual station run times must also be set. This will generally include selecting the number of times the station will be scheduled to run on each watering day and setting soak times between repeat watering cycles; setting water day schedule; and the percentage adjustment water times that are slightly dry or wetter than the selected values.

Thus, the use of contemporary smart irrigation system controllers requires a rather significant amount of user time and effort to achieve water savings. In addition, it is also often necessary for users to purchase a 1 year, 2 year, or 3 year local weather information contract from a participating service to receive the daily information required by these controllers. These contracts also often have default payment clauses, which can be costly.

Accordingly, it would be advantageous to provide an irrigation system that takes into account actual whether conditions in order to maximize water savings without the complications described above.

### SUMMARY

It is an object of the present invention to provide a simple and reliable way to get information regarding actual moisture conditions in each zone of an irrigation system, if desired, or a single representative area, and use this information to set the desired run times for each zone automatically without the need for the customer to guess or estimate values for the parameters discussed above.

A control system for controlling at least one irrigation station in an irrigation system in accordance with an embodiment of the present application includes a moisture probe operable to gather moisture information regarding moisture present in soil at the irrigation station and to periodically transmit the moisture information wirelessly and a controller operable to receive the moisture information and operable to provide control signals to control the irrigation station based on the moisture information to maintain a desired moisture level at the water station.

A method of controlling an irrigation zone of an irrigation system in accordance with an embodiment of the present application includes providing a moisture probe, gathering moisture information regarding a moisture level of the soil around the moisture probe, periodically transmitting the moisture information wirelessly, receiving the moisture information at a controller; and providing control signals from the controller to the irrigation zone to control a sprinkler thereof based on the moisture information.

Other features and advantages of the present invention will become apparent from the following description of the invention which refers to the accompanying drawings.

### BRIEF DESCRIPTION OF THE DRAWINGS

FIG. 1 shows a remote wireless moisture sensing probe in accordance with an embodiment of the present application.

FIG. 2A shows a top view of the wireless moisture sensing probe of FIG. 1.

FIG. 2B shows a side view of the wireless moisture sensing probe of FIGS. 1-2

FIG. 3 illustrates an exemplary block diagram of the circuitry of the moisture sensing probe of FIGS. 1-3.

FIG. 4 shows an exemplary controller face of an irrigation controller suitable for use with the wireless moisture probe of FIGS. 1-3 with a function selection switch shown in an automatic position, a sensor selector switch in a bypass center position and with the day of the week and current time displayed.

FIG. 5 shows the exemplary controller face of FIG. 4 with the sensor selection switch in a rain switch position.

FIG. 6 shows the exemplary controller face of FIG. 4 with the sensor select switch in an “in ground moisture probe” position and showing the time of day, moisture level set, and moisture level measured above each station number that has a moisture probe installed.

FIG. 7 shows the exemplary controller face of FIG. 4 with the function selector switch set at station 1 and sensor selector switch set at the in ground moisture probe position and the moisture level probe moisture level set value shown along with the moisture level measured, station number programmed and set wilt moisture minimum level.

FIG. 8 shows the exemplary controller face of FIG. 4 with the function selector switch set at station 1, but with the sensor selection switch set at the rain switch position and the run time, station number and program shown.

FIG. 9 shows the exemplary controller face of FIG. 4 with the selector switch set to display program contents and the program selector switch set to program A and the sensor selector switch set to “in ground moisture probe” and showing all days that program is selected to run, start time selected, stations selected to run with moisture set point and moisture measured.

### DETAILED DESCRIPTION OF THE EMBODIMENTS

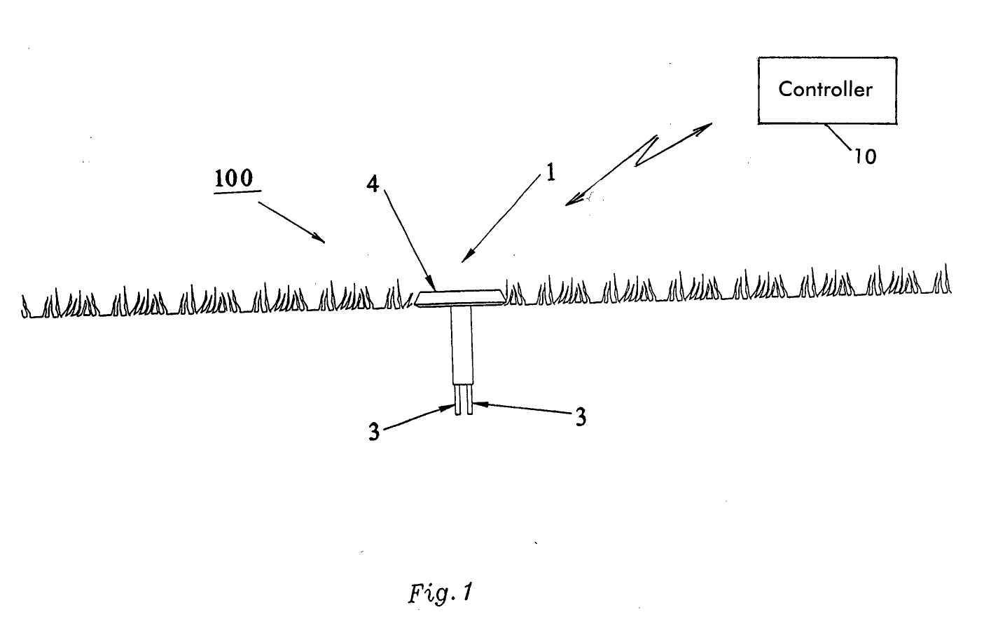

The present application relates to a very simple and reliable way to get information regarding actual moisture conditions in each area, or zone, of an irrigation system. In particular, a wireless moisture probe 1 is inserted into a slit in the ground in each desired area, or zone. The wireless moisture probe 1 preferably periodically transmits moisture information along with identification information unique to the probe to identify the specific probe that is sending the moisture information to a controller 10 that provides control for the irrigation zone. The probe 1 and controller 10 thus provide an irrigation control system 100 (see FIG. 1).

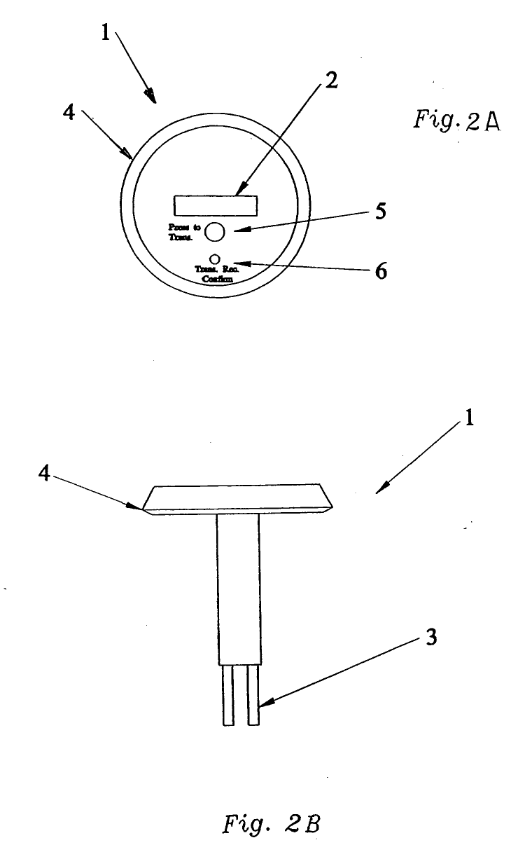

In a preferred embodiment, the probe 1 has a substantially flat top portion 4 (see FIG. 2A) that is preferably substantially flat and even with the grass or grade when the probe 1 is inserted into the slit so that it does not interfere with landscape maintenance. The moisture information gathered from the probe 1 is preferably periodically transmitted wirelessly to the irrigation controller 10 that uses the information to set the run times for each area, or zone, in the irrigation system. In a preferred embodiment, run times may be continuously modified to maintain a desired moisture level at each location in the irrigation system.

In a preferred embodiment, the desired moisture level is determined based on a first measurement of moisture information by the probe 1. Thus, actual moisture information is provided by the probe 1 to aid in resetting run times without the need for all of the guessing and other needless work that conventional smart controllers require.

FIG. 1 illustrates a wireless soil moisture probe 1 in accordance with an embodiment of the present application in wireless communication with the controller 10. The probe 1 is preferably placed in the soil with its sensing electrodes 3 positioned at the ideal root zone, i.e. about 6 inches deep. It is noted, however, that depending on the plant life in the area, the ideal root zone may be somewhat higher or lower, for example, for grass, the ideal root zone is about 4 inches deep. In a preferred embodiment, the probe 1 includes a power source (12,13), for example, a battery 12, or solar cell 13, or both, if desired, so that it is self powered.

Moisture sensing technology suitable for use with the moisture probe 1 is known in the industry and is very reliable when properly executed. In a preferred embodiment, the electrodes 3 are insulated from the soil to avoid sensing the ionization of soil nutrients such as phosphate and nitrogen compounds and salts. Such ionized particles have caused substantial problems in the past resulting in confuse moisture level readings.

A typical electrical circuit for the moisture probe 1 generally includes two insulated electrodes 3. Water is a polar molecule, and thus, changes the dielectric characteristics of the soil that surrounds it. As a result, the soil around the electrodes 3 causes the electrodes to have a different capacitive impedance for different moisture levels in the soil.

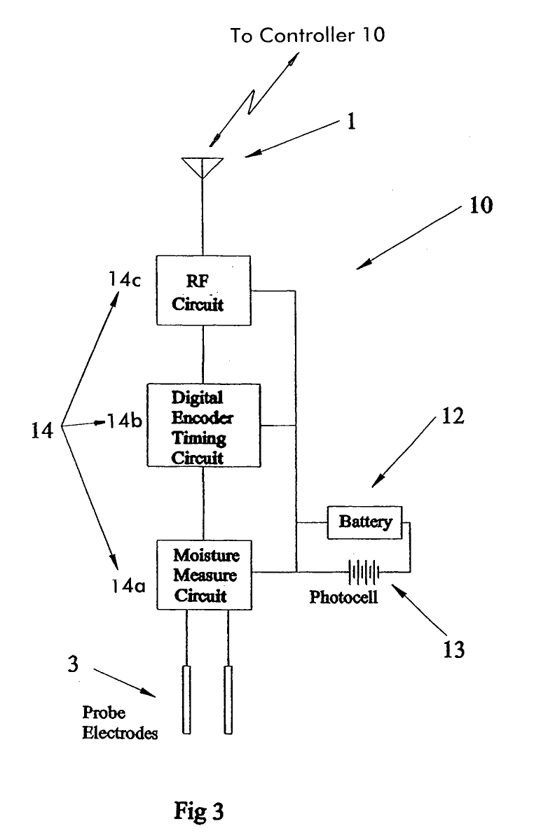

FIG. 3 illustrates a block diagram of an exemplary circuit suitable for use in the moisture probe 1 of the present application. In this particular embodiment, a battery 12 is illustrated along with a photocell 13 as the power source, however, any suitable power source may be used. Further, if desired, the photocell 13 may be used to recharge the battery 12, if desired. The moisture measuring and transmitting circuitry 14 includes moisture measuring circuit 14a, a digital encoder 14b and a transmitter/receiver (transceiver) circuit 14c. As illustrated, the moisture measuring circuit 14a is connected to the electrodes 3. Preferably, one leg of an electrical bridge circuit formed by the moisture sensing circuit 14a and the probes 3 is energized with a 1000 to 10,000 Hz current signal. A change in the imbalance across this bridge is representative of changes of moisture level in the soil surrounding the electrodes 3. This imbalance information is preferably digitized by the digital encoder 14b and periodically transmitted by the transceiver circuit 14c for minimum power consumption. The information is preferably received by a receiver at, or in, an irrigation controller (controller 10, for example). The circuit elements described above are all completely potted and molded to be totally waterproof as well. In a preferred embodiment, the battery 12 for example is rechargable such that it need not be removed.

The electrodes' 3 ability to sense moisture in the soil is not based on direct contact with the soil, but depends on the electrical field around the electrodes. The capacitive impedance of the electrodes 3 is affected by the number of water molecules present in the surrounding electric field as is mentioned above.

Another approach would be to simply sense the power factor shift in phase between voltage and current due to the capacitance change between the electrodes and soil and relate this to a relative number i.e. 1 through 50. If the capacitive sensing moisture electrode 3 is connected into one leg of an electrical bridge circuit, the change of electrical impedance due to high frequency will cause the bridge circuit to become more or less unbalanced and the imbalance is read as a voltage difference across opposite sides of the bridge circuit. This value is related to the moisture content of the soil.

It is preferable to install the electrodes 3 into the ground with a minimum of disturbance of the surrounding soil root structure and existing moisture. The electrodes 3 are preferably slipped into a slit down to the depth of the area in which the moisture level is to be measured (generally root depth). More that one set of electrodes 3 may be provided on the probe 1, if desired, to allow the probe to measure moisture at different depths.

Once the probe 1, more specifically, the electrodes 3, are inserted into the soil, they are energized by a high frequency electric current. The change of capacitive impedance is essentially a linear representation of the change in volumetric percentage of water content of the soil regardless of soil type. This electrical signal is digitized and transmitted to the controller wirelessly via the transceiver circuit 14c. Transmission will generally take place periodically, preferably before and after watering events. In addition, as can be seen in FIG. 2A, for example, the probe 1 may include a measure and transmit button 5 on its top 4. If a user presses this button, the probe 1 will measure the moisture content of the soil and transmit the moisture data even if it is not one of the periodic transmission times that are regularly scheduled.

There are available standard wireless transceiver (transmitter/receiver) chips that provide a variety of ways to code transmitted information. Some are serialized chips with a different identification code that match their serial numbers. In this manner, an individual moisture probe 1 of a plurality moisture probes that may be placed in plural zones of the irrigation system may be recognized by the controller 10 that receives the moisture data.

In a preferred embodiment, the moisture information is transmitted at a relatively high frequency, preferably as a series of coded pulses. The frequency range is preferably between 928 MHz to 2-3 GHz. Multiplexing through the assigned frequency band is preferable to allow higher transmitter power levels for longer distance transmission without a license.

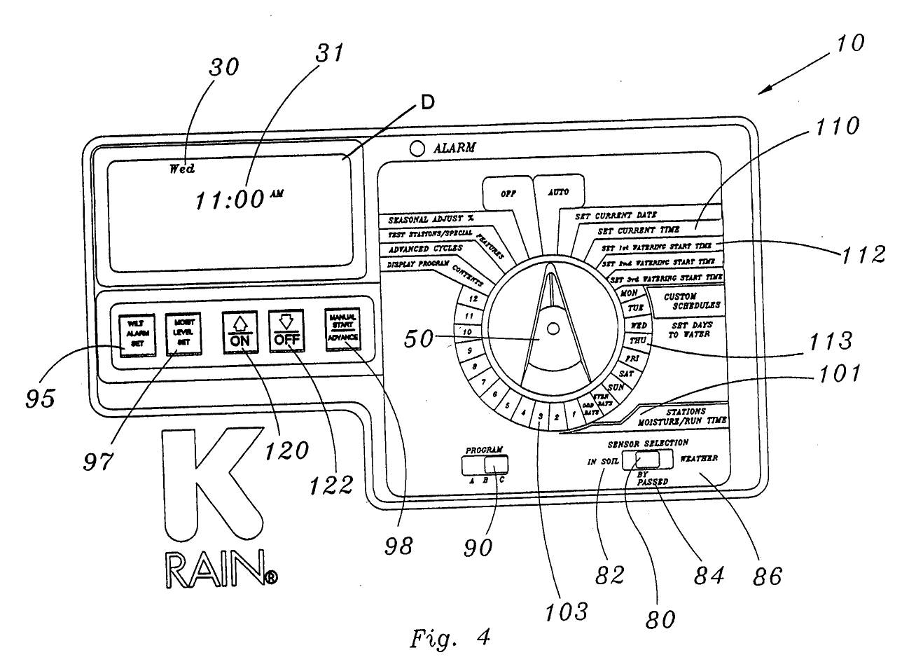

FIG. 4 is an exemplary illustration of a face of the irrigation controller 10 that may be used to receive the moisture information from the probe 1. In a preferred embodiment, the controller 10 will receive and record the moisture information and determine the change in the moisture level at the location of the probe 1 on a daily basis. The moisture information over the course of the day may be used to determine the ET (evaporation and transpiration loss) at the probe 1. Further, the data maybe used to adjust run times for sprinklers in that location. No more complicated weather equipment is needed to know the ET and how to set the run time for the precipitation rate sprinkler in the irrigation zone.

Since the controller 10 preferably receives the moisture information from the probe 1 several times a day, the controller not only determines the exact moisture level at the probe 1, but it can also determine the ET which is generally determined based on water lost per day. However, the ET may be based on water lost over any particular unit of time.

The controller 10 may also be used to determine the precipitation rate PR of the sprinkler at the probe 1 as well. The precipitation rate is a measure of precipitation delivered per unit of time. Thus, the PR may be determined based on comparing a moisture level before activating the sprinkler for a predetermined period of time and then after the sprinkler is run for a predetermined period of time and given time to soak in.

Based on the ET, the controller 10 may determine how much precipitation must be provided on allowed watering days to keep up with the actual loss of water in the soil at the location of the probe 1. Using the precipitation rate PR and the previously discussed ET which may vary from day to day and within yearly ranges, the controller 10 can automatically calculate a run time to replace the lost moisture during the elapsed time between scheduled irrigation cycles since the amount of water delivered by the sprinkler is known based on the PR and the water loss rate is known based on the ET.

As can be seen in FIG. 4, the controller 10 preferably includes a display D operable to display information to the user. In addition, various input devices are provided to allow the user to input information, set preferences and select information to be viewed on the display D, for example. A dial 50 is provided to allow a user to select one of a plurality of days, by selecting one of the day positions 113, or one of a plurality of irrigation stations by selecting a station position 103 for viewing or programming. A sensor selecting switch 80 is also provided to allow the user to select a sensor source for the controller 10. When the switch 80 is in the “in soil” position 82, the controller 10 utilizes the moisture information received from the probe 1 to modify run times. The controller 10 utilizes weather information to modify run times in a manner similar to the conventional controllers described above. When the switch 80 is in the “bypass” position, the controller 10 simply uses the run time set by the selected program, A, B, C indicated by switch 90.

The program select switch 90 allows the user to select a particular preset program, either to view or select the parameters therefore. The dial 50 also preferably includes a position “Display Program Contents” that allows the user to view all parameters of a selected program at the same time on the display D.

In addition, the controller 10 preferably includes an “ON” switch 120 and an “OFF” switch 121 to turn the controller 10 on and off. In addition, a moisture level set button 97 is used to set, or confirm, a desired moisture level and a wilt alarm set button 95 to set a wilt alarm. All of these input devices allow the user to program the controller 10 and/or to view program parameters.

Once the irrigation controller 10 has established contact with a probe 1, and preferably a plurality of probes, each of which is positioned in a different irrigation zone, the controller 10 is preferably calibrated. In one embodiment, the transmit button 5 on each of the probes 1 is pressed in a particular order, for example. This results in each probe transmitting moisture information, and preferably identification information related to each probe 1. In this manner, the controller 10 recognizes each of the probes 1. This can be done before the probes 1 are installed or after installation in their locations or as each additional probe is added.

In order to set a desired moisture level for each irrigation zone, in a preferred embodiment, the controller 10 runs an irrigation station (or irrigation zone) where a probe 1 is installed long enough to saturate the ground for a normal run time for ½ inch of precipitation to be applied. After a delay of several hours to allow the moisture to penetrate into the soil, a moisture level is measured. This level is used to provide a first cut at a desired moisture level for that zone. Based on this desired level, and future measurements, the controller 10 may vary program run times to provide enough water to maintain this desired level.

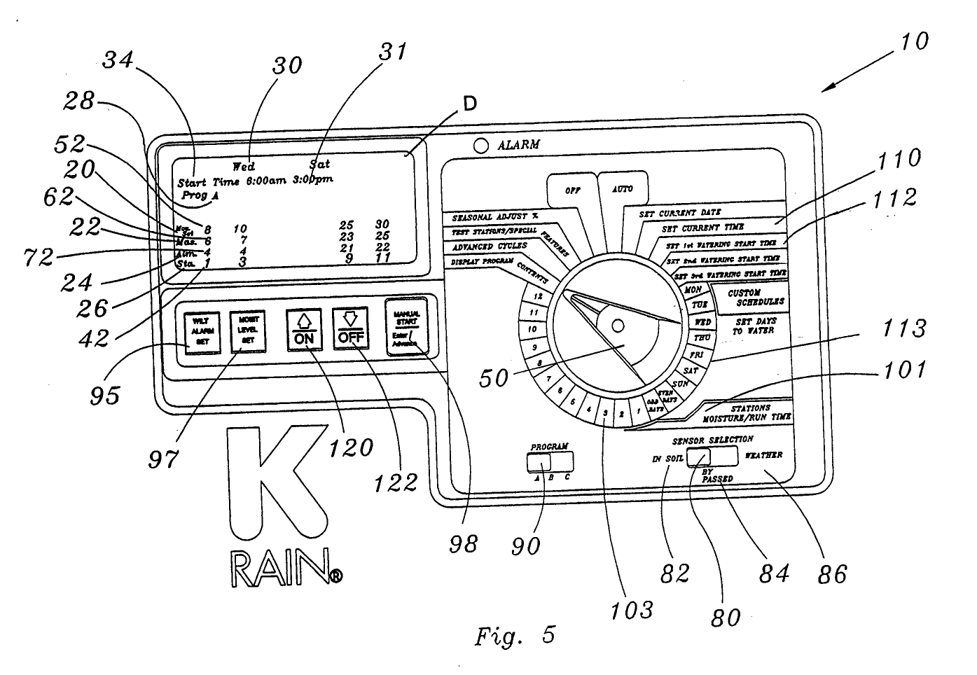

In one embodiment, the volume level of moisture in the soil may be used to determine the moisture volume percentage in the soil and display it as a number on the display D. If the plant material appears healthy in that area, the percentage of water can be assumed to be adequate water for the plant material and the controller 10 set as shown in FIG. 5, for example, to provide this volume percentage of moisture in the soil at the specific location where the probe 1 providing the moisture data is located. The absolute accuracy of this number is not important, only changes in moisture level. As can be seen in FIG. 5, moisture volume percent 20 is shown as “Mos. SET” for the desired moisture level that is set. The as measured moisture level “Mos.” 22 is also displayed. A permanent wilt or desired minimum moisture level can also be set as shown at 24 “Alm.” An alarm may be set to signify to a user that the measured moisture level has dropped below the wilt moisture level to signal the user that it may be time to call for service.

In a preferred embodiment, a different condition can be set for each station that is scheduled to run for a selected Program A, 28, for example. The entire contents of Program A are also preferably displayed on the display D as shown in FIG. 5 with the controller 10 dial 50 in the “displayed program.” Program A is scheduled to run on Wednesday 30 and Saturday 32, with start times 34 of 6:00 AM 36 and 3 PM 38 and run stations 1 (42), 3 (44), 9 (46) and 11 (48). The actual desired moisture level set points 52, 54, 56, and 58 for each irrigation station is also displayed. At the time the selector switch 50 is set to display the irrigation program contents, the actual last measured of moisture levels 62, 64, 66, and 68 for each of the stations as selected and programmed to run in the Program can be displayed. Also, the wilt alarm minimum moisture level can be displayed as set 72, 74, 76 and 78.

The controller 10 may be set to default to a ten minute run time for each station with these run times adjusted as necessary based on the calculated ET and PR for each station as noted above. When the controller 10 is in “in soil” mode, as the dial is turned to each day position 113, for each zone, the moisture level is displayed. If the moisture level is adequate, the current reading can be “confirmed” with the button 97 to set this as the desired moisture level for this zone.

The controller 10 can simply divide the moisture lost between irrigation cycles by the moisture added for a known run time given the known PR to determine a new run time to maintain the desired moisture percentage in the soil in the area of the probe 1. The set point can be adjusted up or down to see what the effect is on the plant appearance to optimize soil moisture content if desired for least water use.

The PR and ET are preferably used by the controller 10 to calculate new run times that are only of the duration necessary to replace the moisture lost to ET between watering events. Once the controller establishes the ET and PR, it preferably does not use the default run time (i.e. 10 minutes) if the controller is in the “in ground” mode.

Normally, irrigation schedules are dictated by water authorities and watering is limited to certain days of the week. Generally, water savings are accomplished by complying with water restrictions and not watering any more than necessary to maintain adequate moisture levels for different types of plants at their root depth when it is not necessary. The controller 10 prevents watering on allowed days beyond field capacity if there has been rainfall.

Different soil types have different field capacity or different volumes of water that can be held before runoff and waste occurs. The probe 1 and controller 10 of the present application allow the probes 1 to be inserted in the ground in contact with the soil. The surrounding soil and root zones are not disturbed and there is no need to know the soil type. The probe 1 provides moisture information to determine the volumetric moisture level of the soil. If the plant is healthy it is presumed that this level is a satisfactory moisture level.

When a moisture level falls below a certain level, the plant will die. Generally, this moisture level is called the permanent wilting point. The optimum water level is the field capacity and irrigation programs are generally programmed to allow a 50% reduction in field capacity prior to watering. If the general soil type is known, the field capacity for the soil type can be programmed as the maximum moisture level for the zone and the permanent wilting point can be programmed as the minimum moisture level for the zone.

If an installer or homeowner wants an indication of soil type, the controller 10 can be used to indicate the soil present in a zone with a probe 1, by running the sprinkler in the zone for a period of time to fully saturate the ground, then waiting a period of time to allow infiltration of the water. The maximum volume of water achieved is indicative of the soil type, which can be determined based on comparison to industry standard charts, for example. For example, sand's maximum water content is 10% and clay's maximum moisture content is 36%. Thereafter if the soil is allowed to dry out until the plant wilts, a moisture level at wilting of 21% will indicate the soil is clay and a moisture level of 4% will indicate the soil is sand.

The probe 1 and controller 10 of the present application provide a vastly simplified control system for an irrigation system that provides smart irrigation control. One or more probes 1 can be easily linked to the controller 10 and the controller easily synchronized or calibrated to the variety of irrigation zones, each including a probe 1 by simply selecting each zone using the dial 50 and then activating the button 5 on the corresponding probe 1 in the zone. The controller 10 then receives the moisture data, and identification data from the probe 1 and associates it with that zone. Both the set moisture level and the measured moisture level number, i.e. 1 through 50 will be displayed for each irrigation zone. The desired set level can be changed at any time. The controller 10 preferably also has a safety that will automatically water a zone prior to permanent wilt regardless of the schedule. After an emergency run time, the moisture level is checked, if the moisture level does not increase, an alert may be transmitted by telephone to the homeowner or sprinkler installer indicating that the irrigation system is not functioning, i.e. there is a broken valve, sprinkler, pipe, etc.

Further, the controller 10 of the present application is also more accurate than conventional controllers. All kinds of satellite weather data or weather station data that is provided in conventional controllers is inaccurate since cloud movement and the amount of rain that actually falls on an area may vary widely even over a few miles.

The probes 1 and the controller 10 of the present application offer a much less expensive way to get exactly what is needed to set an irrigation controller for providing only the amount of water needed for each area that it controls the irrigation for. The sprinkler preferably provides matched precipitation and the sprinkler's precipitation rate is multiplied by the controller time to know exactly how much water is being applied to replace the water being lost to the measured ET in each of the different type environments of the irrigation system on each allowed or scheduled day for running the irrigation controller.

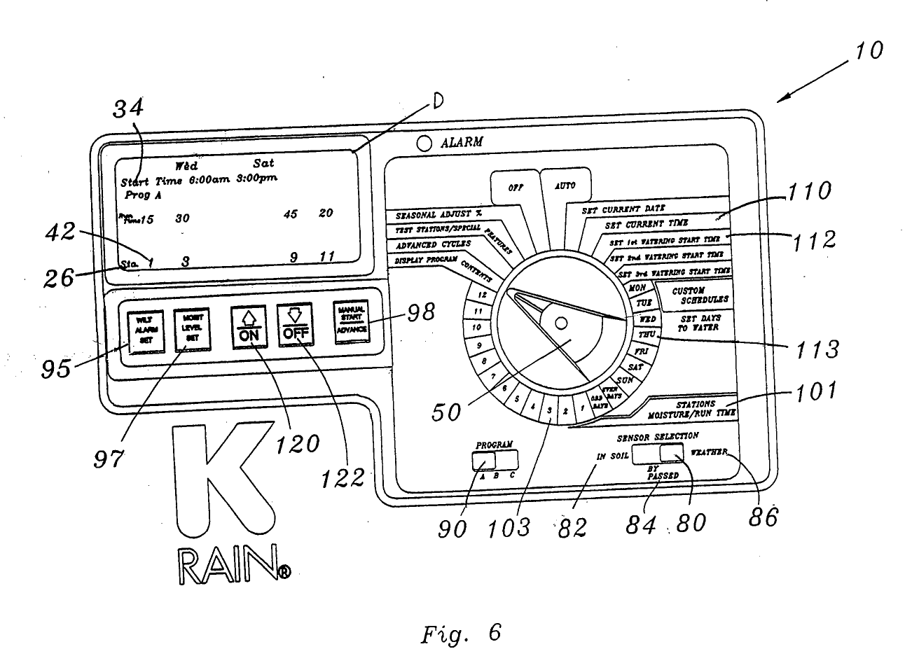

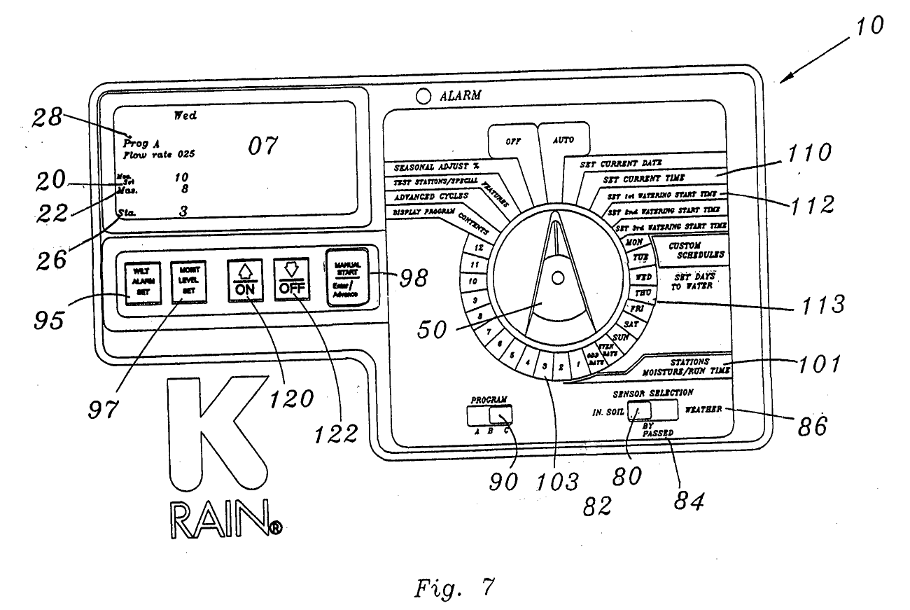

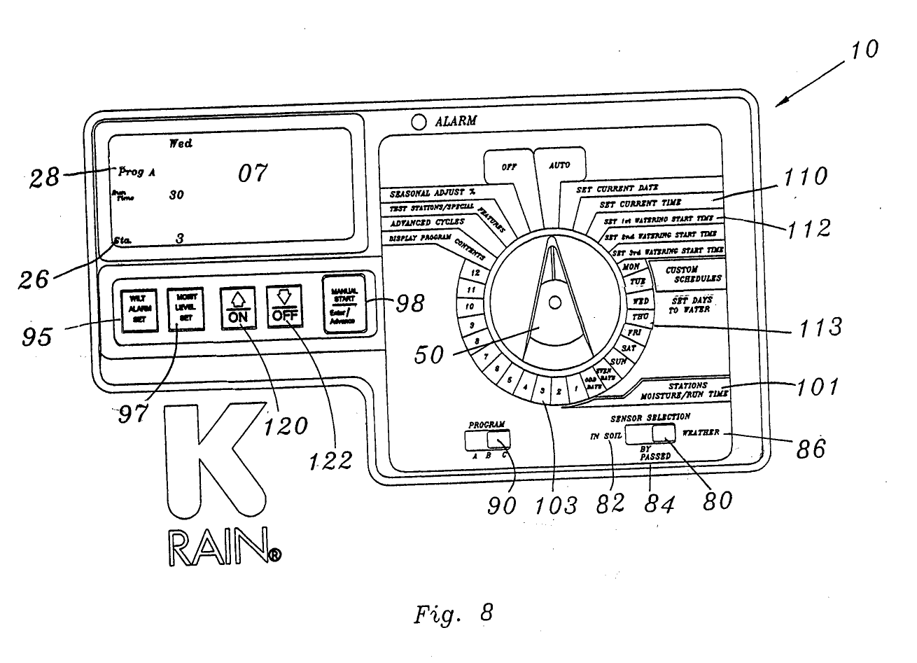

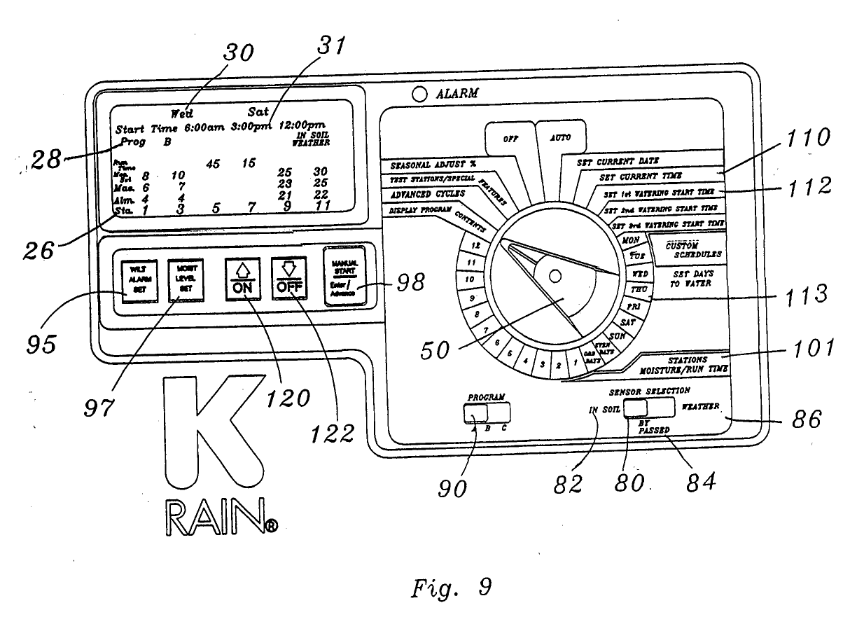

In FIG. 6, the parameters set for program A are displayed on the display D. In FIG. 7, the measured moisture level at station 3 is illustrated along with the desired moisture level. The controller 10 is set on auto and in the “in soil” position so that moisture information from the probe 1 is being used to modify run times. In FIG. 8, the run time for station 3 is illustrated on display D, however, weather information is being used to set run times, rather than moisture information from the probes 1 since switch 80 is set on “weather.” In FIG. 9 all parameters of Program A are displayed along with the measured and desired values for all of the stations involved in that program with the dial 50 set on “display program” and the switch 80 set to “in soil.”

Thus, the moisture probe 1 and controller 10 of the present application provide an irrigation control system that takes actual moisture conditions into account to modify irrigation programs to maximize water usage. The probes provide moisture information periodically to the controller 10 which uses this information to determine the necessary amount of water to replace water loss for each zone of the irrigation system and then allows for run times to be modified in each zone to replace the water that was lost to maintain a desired moisture level. This is much simpler that previous smart controllers which required users to provide substantial information in order to provide such control.

Based on the moisture information, the controller 10 determines the precipitation rate PR of a sprinkler in the area of the zone and can also determine the evaporation and transpiration loss rate ET in the area of the probe. A method of automatically determining the precipitation rate of a sprinkler used in an irrigation system preferably includes determining the change in soil moisture level; recording a moisture level prior to running sprinklers; allowing time for soak into root level; and recording the moisture level after running the sprinkler and after the soak in time has elapsed. The change in moisture level with the sprinkler run time used is the precipitation rate of the sprinklers (PR).

A method of automatically determining the ET by use of a periodically transmitting in-ground moisture probe includes recording a moisture level at a first time; recording a second moisture level at a second time; and repeating over a 24 hour period to determine the standard ET (evaporative and transpiration loss). Future run times are preferably automatically set to replace moisture deficiencies using the controller determined ET and PR from the moisture data.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A control system for controlling at least one irrigation station in an irrigation system comprising:
a moisture probe operable to gather moisture information regarding moisture present in soil at the irrigation station and to periodically transmit the moisture information wirelessly; and
a controller operable to receive the moisture information and operable to provide control signals to control the irrigation station based on the moisture information to maintain a desired moisture level at the water station.

2. The control system of claim 1, wherein the moisture probe further comprises:
at least one electrode structured for insertion into the soil to a predetermined depth;
measurement circuitry connected to the electrode and operable to provide a measurement signal indicative of a moisture level in the soil;
a transceiver operable to periodically transmit the measurement signal as the moisture information.

3. The control system of claim 2, wherein the measurement signal is based on a capacitive impedance of the at least one electrode.

4. The control system of claim 3, wherein the controller utilizes the moisture information to determine a precipitation rate provided at the irrigation station.

5. The control system of claim 4, wherein the controller utilizes the moisture information to determine an evaporation and transpiration loss rate for the irrigation station.

6. The control system of claim 5, wherein the precipitation rate and evaporation and transpiration loss rate are utilized by the controller to modify a run time for a sprinkler of the irrigation station required to maintain the desired moisture level at the irrigation station.

7. The control system of claim 6, wherein the desired moisture level is based on moisture information provided by the moisture probe after a predetermined period of time has passed after the sprinkler of the irrigation zone has been activated for watering.

8. The control system of claim 7, wherein the predetermined period of time is set such that water soaks into the soil after watering.

9. The control system of claim 8, wherein the controller further comprises a mode switch operable to select a mode of operation for the controller.

10. The control system of claim 9, wherein a bypass mode is selectable using the mode switch to bypass the moisture information provided by the moisture probe.

11. The control system of claim 10, wherein a weather mode is selectable using the mode switch to utilize weather information to modify run times of a sprinkler in the irrigation zone.

12. The control system of claim 11, wherein the controller further comprises a display device operable to display information to the user.

13. The control system of claim 12, wherein the display shows the moisture information provided by the moisture probe to the user.

14. The control system of claim 13, further comprising an input device operable to enter selection information used to control the irrigation zone.

15. A method of controlling an irrigation zone of an irrigation system comprising:
providing a moisture probe;
gathering moisture information regarding a moisture level of the soil around the moisture probe
periodically transmitting the moisture information wirelessly;
receiving the moisture information at a controller; and
providing control signals from the controller to the irrigation zone to control a sprinkler thereof based on the moisture information.

16. The method of claim 15, wherein the control signals set an on time for the sprinkler based on the moisture information to maintain a desired moisture percentage in the soil at the moisture probe.

17. The method of claim 16, wherein the step of providing control signals further comprises:
receiving first moisture information prior to watering;
controlling the sprinkler to water in the irrigation zone;
receiving second moisture information after watering;
determining a precipitation rate of the sprinkler based on the difference between the first moisture information and the second moisture information.

18. The method of claim 17, wherein the step of providing control signals further comprises:
receiving first loss moisture information after watering;
waiting a predetermined period of time;
receiving second loss moisture information after the predetermined period of time;
determining an evaporation and transpiration loss rate at the irrigation zone based on the first loss moisture information, predetermined time and the second loss moisture information.

19. The method of claim 18, wherein an on time of the sprinkler indicated by the control signals is set based on the precipitation rate and the evaporation and transpiration loss rate.

20. The method of claim 19, further comprising displaying the moisture information on a display device of the controller.
